(19) United States
(12) Patent Application Publication
(10) Pub. No.: US 2024/0140304 A1
(43) Pub. Date: May 2, 2024

(54) LIGHT BAR BRACKET ASSEMBLY FOR A VEHICLE

(71) Applicant: NISSAN NORTH AMERICA, INC., Franklin, TN (US)

(72) Inventors: William J. WEBER, Brighton, MI (US); Dale BUTTERWORTH, Brighton, MI (US)

(21) Appl. No.: 17/974,107

(22) Filed: Oct. 26, 2022

(51) Int. Cl. B60Q 1/32; B60Q 1/00; B60Q 1/26

(52) U.S. Cl. CPC B60Q 1/32; B60Q 1/0041; B60Q 1/2607; B60Q 1/2615

(57) ABSTRACT

A light bar bracket assembly for a vehicle includes a light bar and a bracket assembly. The light bar is configured to receive a light source. The light bar has a first fastener receiving channel and a second fastener receiving channel configured to receive fasteners to secure the light bar to a projector. The bracket assembly is configured to receive the light bar. A gap is defined by a first end and a second end of the bracket assembly through which light is configured to be emitted by the light source.

### BACKGROUND

### Technical Field

The present disclosure generally relates to a light bar bracket assembly for a vehicle. More specifically, the present disclosure relates to a light bar bracket assembly for a vehicle in which a gap is defined in the bracket assembly through which light is emitted by a light assembly.

### Background Information

A light assembly for a vehicle illuminates an external area in the vicinity of the vehicle. The light assembly includes a light bar including a plurality of light sources that emit light to the external area. A bracket assembly secures the light bar to a vehicle structure. Existing light bar bracket assemblies can interfere with the light emitted by the light sources of the light bar.

### SUMMARY

In view of the state of the known technology, one aspect of the present disclosure is to provide a light bar bracket assembly for a vehicle including a light bar and a bracket assembly. The light bar is configured to receive a light source. The light bar has a first fastener receiving channel and a second fastener receiving channel configured to receive fasteners to secure the light bar to a projector. The bracket assembly is configured to receive the light bar. A gap is defined by a first end and a second end of the bracket assembly through which light is configured to be emitted by the light source.

Another aspect of the present disclosure is to provide a vehicle light assembly including a vehicle body structure, and a light assembly connected to the vehicle body structure. The light assembly includes a light bar, a projector, and a bracket assembly. The light bar includes a first light source configured to emit light. The projector is connected to the light bar. The projector includes a second light source configured to emit light. The bracket assembly is connected to the light bar. A gap is defined by a first end and a second end of the bracket assembly through which the light is configured to be emitted by the first light source.

Also other objects, features, aspects and advantages of the disclosed vehicle light bar bracket assembly will become apparent to those skilled in the art from the following detailed description, which, taken in conjunction with the annexed drawings, discloses exemplary embodiments of the vehicle light bar bracket assembly.

### BRIEF DESCRIPTION OF THE DRAWINGS

Referring now to the attached drawings which form a part of this original disclosure:

FIG. 1 is a perspective view of a vehicle equipped with a vehicle light bar bracket assembly in accordance with an exemplary embodiment;

FIG. 2 is a side elevational view of the vehicle light assembly including a vehicle light bar bracket assembly of FIG. 1;

FIG. 3 is an exploded side elevational view of the vehicle of FIG. 1 prior to installation of the vehicle light assembly to the vehicle;

FIG. 4 is a perspective view of a projector connected to an end cap of the vehicle light assembly of FIG. 1;

FIG. 5 is a perspective view of the projector connected to the end cap of FIG. 4 with a light bar received by the end cap and a bracket assembly connected to the light bar;

FIG. 6 is a perspective view of the light bar bracket assembly connected to the light bar of FIG. 5;

FIG. 7 is an elevational view of the light bar bracket assembly connected to the light bar of FIG. 6;

FIG. 8 is a perspective view of the light bar bracket assembly of FIG. 6;

FIG. 9 is an elevational view of the light bar bracket assembly of FIG. 8; and

FIG. 10 is an elevational view in cross section of the light bar bracket assembly connected to the vehicle of FIG. 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

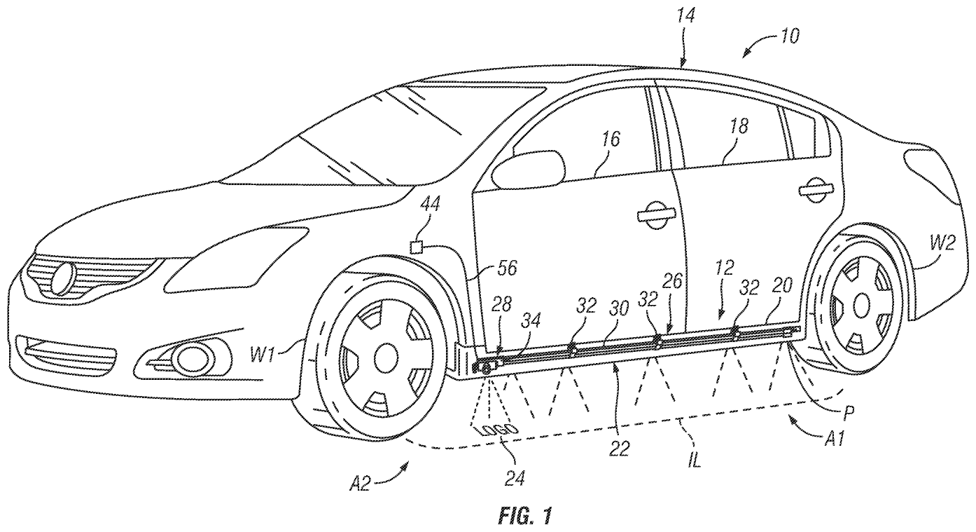

Referring now to FIG. 1, a vehicle 10 equipped with a light assembly 12 is illustrated according to an exemplary embodiment. The vehicle 10 includes a vehicle body structure 14, a front door 16 (illustrated as a driver side), a rear door 18 (illustrated as the driver side), and a rocker panel 20. In the illustrated embodiment, the rocker panel, or sill, 20, which includes a rocker trim panel, is considered a component of the vehicle body structure 14 that at least partially defines an underbody 22 of the vehicle 10. Although the light assembly 12 is illustrated as being disposed on the driver side of the vehicle 10, it will be apparent to those skilled in the vehicle field from this disclosure that the rocker panel 20 and the vehicle 10 can include an additional rocker panel 20 (not shown) extending along a passenger side or a rear end, which can be similarly equipped with components of the light assembly 12 of the illustrated embodiment.

The underbody 22 defines an outer perimeter P of the vehicle 10. The light assembly 12 draws electrical power from an electrical system of the vehicle 10.

The light assembly 12 illuminates an illuminated area IL external of the vehicle 10. The illuminated area IL is preferably located beneath the underbody 22 and also in the vicinity of the outer perimeter P of the vehicle 10. The illuminated area IL can extend the length of a side of the vehicle 10 and can encompass the area located directly beneath the underbody 22, the area located inboard of the perimeter P and the area located outboard of the perimeter P. Therefore, the illuminated area IL can include the ground that is located beneath the underbody 22 and in the vicinity of the outer perimeter P of the vehicle 10. While the illuminated area IL is illustrated as being projected near the driver side of the vehicle 10, it will be apparent to those skilled in the vehicle field that the light assembly 12 can be implemented with the passenger side to illuminate the ground in the vicinity of the passenger side of the vehicle 10. It will be further apparent to those skilled in the vehicle field from this disclosure that while the light assembly 12 is illustrated as illuminating the ground in the vicinity of the driver side doors, it will be apparent to those skilled in the vehicle field from this disclosure that the light assembly 12 can illuminate different external areas that are in the vicinity of the vehicle 10 as needed and/or desired.

The light assembly 12 of the exemplary embodiment can be considered an underglow light assembly or ground effects that is attached to the underbody 22 or beneath the chassis of the vehicle 10. The light assembly 12 is preferably connected to the vehicle underbody 22 and disposed inboard of the rocker panel 20. The light assembly 12 can be disposed in any suitable location of the vehicle 10. The light assembly 12 projects light towards the illuminated area IL. The light assembly 12 is oriented and/or constructed to illuminate the illuminated area IL either alone or in combination with the exterior lights (e.g., taillights or parking lights) of the vehicle 10. It will be apparent to those skilled in the vehicle field from this disclosure that the light assembly 12 can be implemented to illuminate the illuminated area IL by itself or in combination with other exterior lights of the vehicle 10.

The rocker panel, or sill, 20 is a rigid panel preferably made of a durable material, such as stamped steel. The rocker panel 20 extends longitudinally along the front and rear doors 16 and 18 and is disposed below the front and rear doors 16 and 18. The rocker panel 20 extends between a front wheel well W1 and a rear wheel well W2 along the bottom sides of the vehicle 10. The rocker panel 20 forms the juncture of the underbody 22 with the front and rear doors 16 and 18 and at least partially defines the outer perimeter P of the vehicle 10. It will be apparent to those skilled in the vehicle field that the vehicle 10 additionally includes a passenger side rocker panel (not shown) that also at least partially defines the outer perimeter P of the vehicle 10. The rocker panel trim is a rigid piece of plastic or metal trim that is placed over the rocker panel 20. The rocker panel trim is fixedly attached to the rocker panel 20 by any suitable fastening means to conceal or cover all or a portion of the rocker panel 20.

The light assembly 12 is disposed on one or both sides, and/or at a rear of the vehicle 10 as needed and/or desired. The light assembly 12 operates to illuminate the illuminated area IL that is the vicinity of the rocker panel 20. The light assembly 12 of the exemplary embodiment is mounted at the underbody 22 of the vehicle 10 for illuminating the illuminated area IL in the vicinity of the vehicle 10.

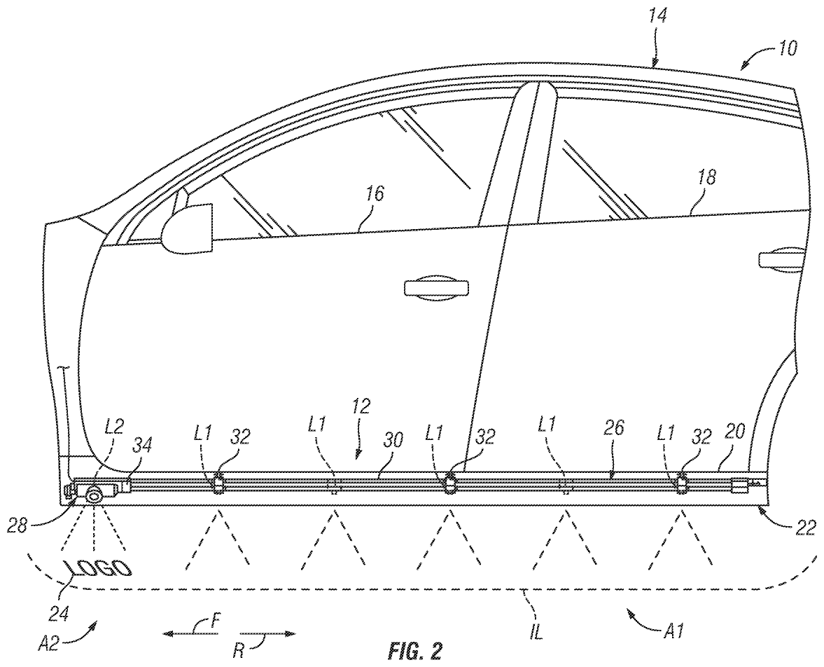

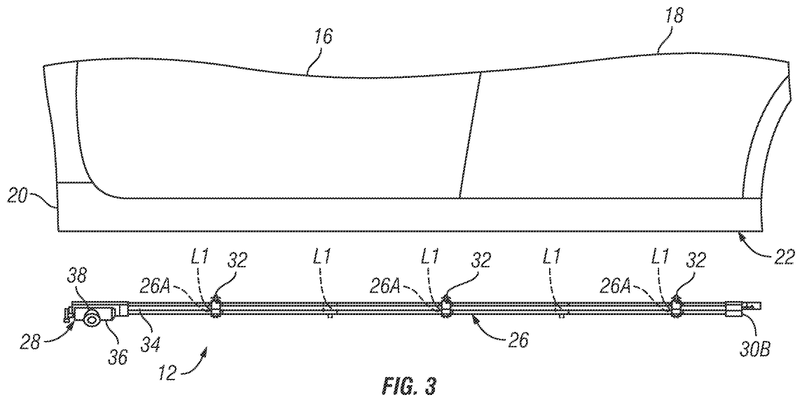

Referring to FIGS. 2 and 3, the light assembly 12 includes a light bar 26 and an image projector 28. The light bar 26 includes a fixed structure 30 and a plurality of light sources L1 that are long-life LEDs disposed on the fixed structure 30 via base members 26A. The light sources L1 are preferably shielded in the base members 26A by rubber isolators (not shown) configured to reduce vibrations and improve component life. Therefore, the light bar 26 includes at least one light source L1 that is preferably an LED. The light bar 26 preferably includes a plurality of light sources that are LEDs. The light sources L1 can be surface-mounted LEDs configured to emit light with any of a variety of colors, color temperatures, or other properties.

The light bar 26 is configured to illuminate a first external area A1 that is in the vicinity of the vehicle 10, as shown in FIGS. 1 and 2. The first external area A1 is part of the illuminated area IL. The fixed structure 30 of the light bar 26 is preferably configured to be assembled to the rocker panel 20, as shown in FIGS. 1-3 and 10. Alternatively, the fixed structure 30 is configured to be assembled to a suitable component of the vehicle body 14. The fixed structure 30 is preferably an elongated member extending in a longitudinal direction of the vehicle 10. The light sources L1 are distributed along a longitudinal length of the fixed structure 30. The light sources L1 are fixed to the fixed structure 30 and are configured to illuminate the first external area A1 that is in the vicinity of the vehicle 10. The fixed structure 30 is connected to the rocker panel 20 by at least one bracket assembly 32. Preferably, three bracket assemblies 32 are equidistantly spaced along the fixed structure 30 of the light bar 26, as shown in FIG. 3. The fixed structure 30 is made of any suitable material, such as extruded aluminum. The bracket assembly 32 is made of any suitable material, such as steel, such as fourteen gauge steel sheet metal.

The fixed structure 30 can also be configured to function as an auxiliary mounting component for the light assembly 12. For example, the fixed structure 30 can emit and/or distribute light produced by the light sources L1 of the light assembly 12. The fixed structure 30 can also include features for effecting a light distribution of the light assembly 12. For example, the fixed structure 30 can be configured to distribute the light produced by the light sources L1 and projected towards the first external area A1. For example, the fixed structure 30 can include one or more angled facet(s) that can distribute light produced by the light sources L1 at different desired angles. Additionally, the fixed structure 30 can include reflective material to deflect light across the underbody 22 and around the outer perimeter P of the vehicle. In the illustrated embodiment, while the light bar 26 is illustrated as including five light sources L1 distributed along the fixed structure 30, it will be apparent to those skilled in the vehicle field from this disclosure that any suitable number and spacing of the light sources L1 of the light assembly 12 can be used.

The light sources L1 are connected to the fixed structure 30, and the image projector 28 is connected to an end of the fixed structure 30, as shown in FIGS. 1-7 and 10. The image projector 28 is fixed to the fixed structure 30 and is configured to project an image 24 onto a second external area A2. In the exemplary embodiment, the image projector 28 is a logo projector that projects a logo or emblem (e.g., the projected image) 24 of the vehicle 10. However, it will be apparent to those in the vehicle field from this disclosure that the image projector 28 can project other types of images (e.g., the date or time information) and/or messages (e.g., “welcome”).

The image projector 28 is configured to project an image in the second external area A2 that is in the vicinity of the first external area A1, as shown in FIGS. 1 and 2. The first and second external areas A1 and A2 are adjacent to each other. Additionally, the first and second external areas A1 and A2 can overlap with one another. In other words, the image projector 28 can project the image onto an area that is illuminated by the light bar 26. The second external area A2 is part of the illuminated area IL. The light sources L1 of the light bar 26 and the light sources L2 of the image projector 28 are configured to illuminate the first and second external areas A1 and A2 in concert.

The image projector 28 is fixed to the light bar 26, as shown in FIGS. 1-7 and 10. The light bar 26 includes an end cap 34 that is connected to the fixing structure 30 at a longitudinal end 30A thereof. The image projector 28 is fixed to the end cap 34 connected to the longitudinal end 30A of the fixed structure 30 by conventional means, such as by a fastener 48. The fastener 48 is preferably a bolt connecting the image projector 28 to the end cap 34 of the light bar 26. As shown, the end cap 34 is connected to a forward longitudinal end of the fixed structure 30 of the light bar 26. The end cap 34 is made of any suitable material, such as cast aluminum.

The image projector 28 is connected to the end cap 34 disposed at the forward end of the fixed structure 30 of the light bar 26. As shown in FIGS. 1-3, the image projector 28 and the end cap 34 are preferably disposed below the driver side door 16. It will be apparent to those skilled in the vehicle field from this disclosure that the image projector 28 can be alternatively, or additionally, fixed to a rearward end 30B of the light bar 26. It will also be apparent to those skilled in the vehicle field from this disclosure that the length and location of the light bar 26 can vary such that the location of the image projector 28 will also vary with respect to the underbody 22.

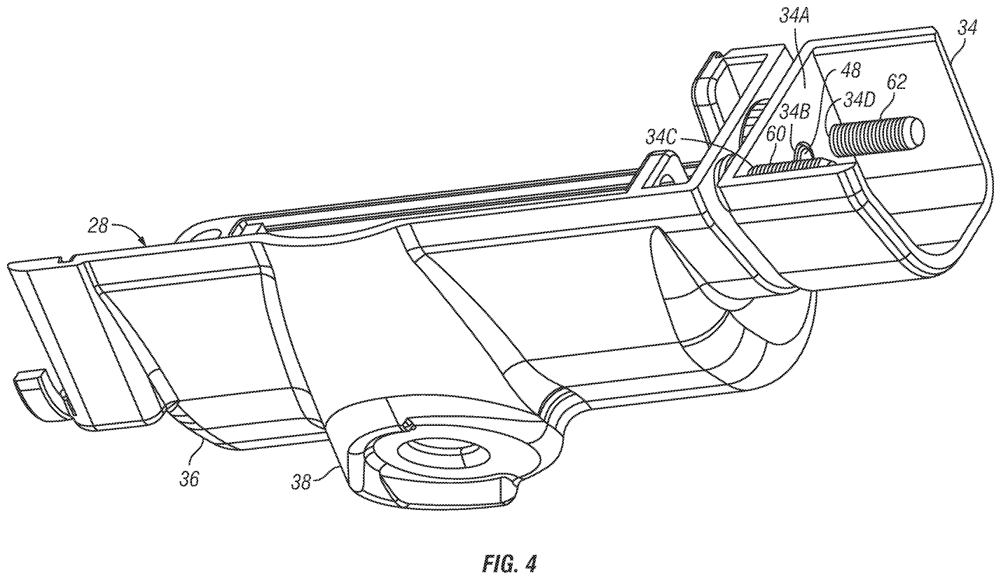

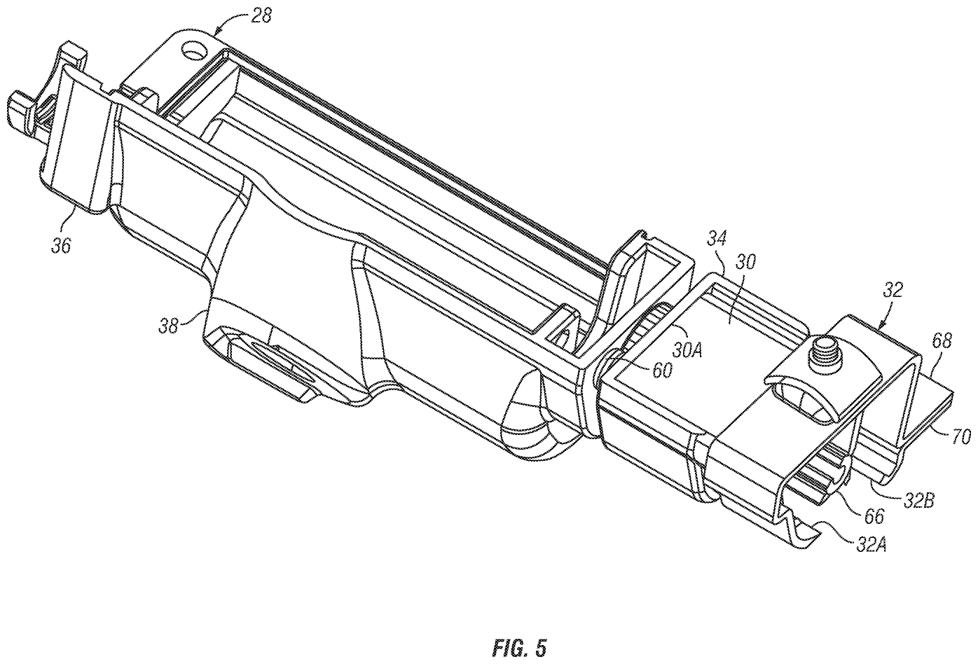

The image projector 28 includes a housing 36 having an emitting portion 38 projecting at an angle with respect to a vertical line perpendicular to the ground, as shown in FIGS. 4 and 5. The housing 36 houses a light source L2 that illuminates the image projected by the image projector 28. The housing 36 is made of any suitable material, such as cast aluminum.

In the exemplary embodiment, the light source L2 of the image projector 28 is preferably an LED. The housing 36 of the image projector 28 further houses a circuit board (not shown) that mechanically supports and electrically connects the light source L2 to an electric control module 44 (FIG. 1) of the lighting system of the vehicle 10. The circuit board can be conventional and include one or more layers of copper laminated onto a non-conductive substrate. The circuit board is electrically connected to the electric control module (ECU) 44 of the lighting system, as will be further explained below. The circuit board is electrically connected to the projector light source L2 of the image projector 28 to regulate electric current transferred from the electric control module 44 to the projector light source L2 of the image projector 28. The projector light source L2 of the image projector 28 preferably emits at least one beam with a wavelength between 15 and 1100 nanometers of visible light.

The image projector 28 includes a lens stack (not shown) that is downstream of the projector light source L2 in a direction in which light is emitted by the light source L2. The lens stack is a set of optics that are transparent plates with a nanometric surface treatment, such as etchings. The etchings provide a diffuse reflection on one side of the plates but not on the other to facilitate the passing of consistent light beams in a particular order. The image projector 28 generates the projected image as projected laser light. The image projector 28 further includes a protective lens (not shown) downstream of the lens stack. The protective lens can include reflective material disposed at a portion of the outer surface of the lens to deflect light that would otherwise be wasted across the underbody 22 of the vehicle 10. The image that is projected can be imprinted onto the surface protective lens. For example, the logo 24 (FIGS. 1 and 2) that is to be projected can be painted or imprinted onto the protective lens.

Referring to FIG. 1, the electric control module or electric control unit 44 electrically controls the components of the light assembly 12. Specifically, the electric control module 44 electrically controls the light bar light sources L1 of the light bar 26 and the projector light source L2 of the image projector 28. As illustrated, the electric control module 44 is part of the light assembly 12. The electric control module 44 preferably includes a microcomputer that includes one or more processor(s) and one or more storage device(s) (i.e., a computer memory device). The memory is any computer storage device or any computer readable medium with the sole exception of a transitory, propagating signal. For example, the memory can be nonvolatile memory and volatile memory, and can includes a ROM (Read Only Memory) device, a RAM (Random Access Memory) device, a hard disk, a flash drive, etc. The storage device can be any a non-transitory computer readable medium such as a ROM (Read Only Memory) device, a RAM (Random Access Memory) device, a hard disk, a flash drive, etc. The storage device is configured to store settings, programs, data, calculations and/or results of the processor(s).

The electric control module 44 is electrically connected to the light bar 26 and the image projector 28. The electric control module 44 provides electrical power to both the light bar 26 and the image projector 28. The electric control module 44 is electrically connected to and electrically operates the light sources L1 and L2 of the light bar 26 and the image projector 28. The electric control module 44 is electrically connected to the light sources L1 and L2 of the light bar 26 and the image projector 28 and to the image projector circuit board by electrical wiring 56, as shown in FIG. 1. The light bar light sources L2 of the light bar 26 and the projector light source L2 of the image projector 28 are configured to activate at substantially the same time to illuminate the illuminated area IL. Additionally, the light assembly 12 preferably activates at the same time as the interior map lights such that the illuminated area IL is illuminated when the interior map lights turn on. Preferably, the light bar light sources L2 of the light bar 26 and the projector light source L2 of the image projector 28 are configured to turn off along with the interior map lights after a predetermined time period. Alternatively, the light bar light sources L2 of the light bar 26 and the projector light source L2 of the image projector 28 of the light assembly 12 and the interior map lights turn off automatically in concert when the vehicle ignition is turned on.

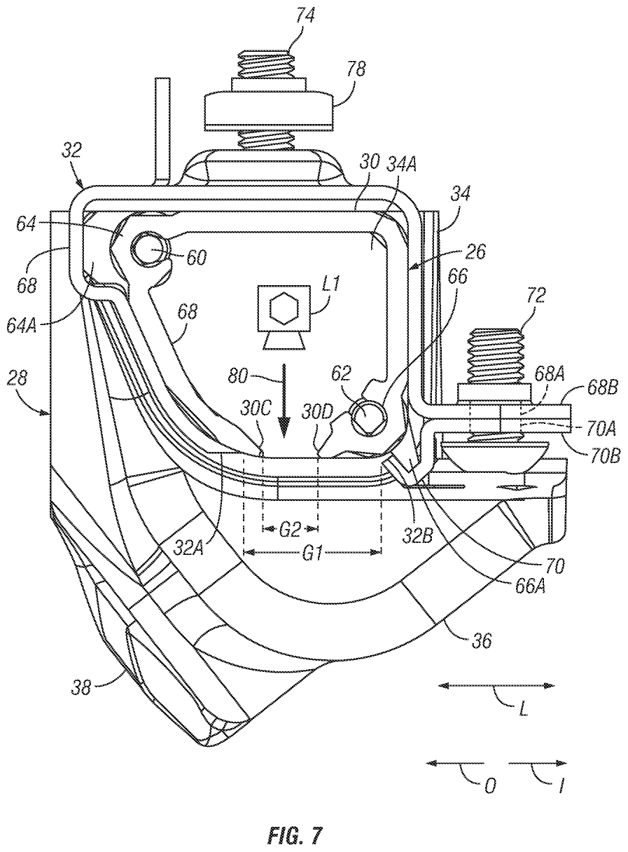

As shown in FIGS. 1-3 and 10, the light bar 26 of the light assembly 12 is configured to be connected to the vehicle body structure 14 of the vehicle 10. The projector 28 is connected to the light bar 26. As shown in FIG. 7, an axial face 34A of the end cap 34 includes a first fastener opening 34B configured to receive the fastener 48 to secure the end cap 34 to the projector 28. As shown in FIG. 7, first and second fasteners 60 and 62 secure the end cap 34 to the fixed structure 30 of the light bar 26. The first and second fasteners 60 and 62 preferably do not engage the housing 36 of the projector 28. The fastener 48 secures the projector 28 to the end cap 34, which is connected to the fixed structure 30 of the light bar 26 by the first and second fasteners 60 and 62. The axial face 34A of the end cap 34A includes first and second fastener openings 34C and 34D configured to receive the first and second fastener 60 and 62. The axial face 34A of the end cap 34 and the projector housing 36 can further include aligned openings to pass the electrical wiring 56 therethrough.

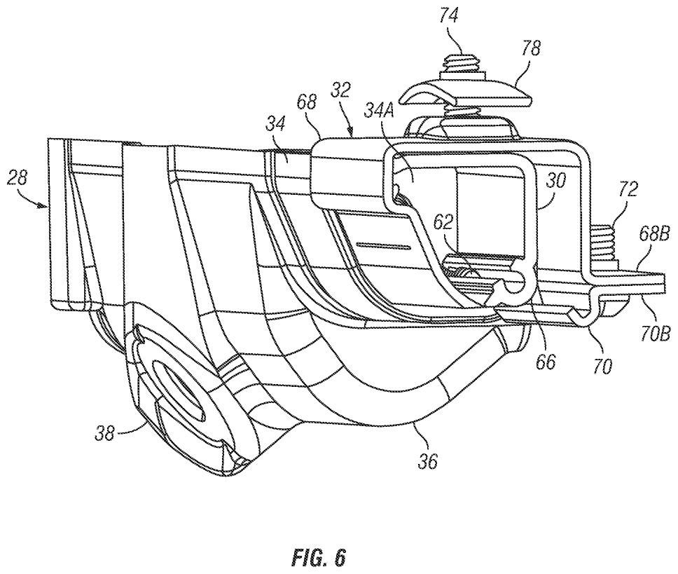

As shown in FIG. 7, the fixed structure 30 of the light bar 26 includes a first fastener receiving channel 64 and a second fastener receiving channel 66 configured to receive the first and second fasteners 60 and 62, respectively, to secure the end cap 34 to the fixed structure 30 of the light bar 26, as shown in FIGS. 6 and 7. The first and second fastener receiving channels 64 and 66 are integrally formed with the fixed structure 30. Each of the first and second fastener receiving channels 64 and 66 includes a strengthening portion 64A and 66A that extends outwardly therefrom. The strengthening portions 64A and 66A are integrally formed with the fixed structure 30. The first and second fasteners 60 and 62 are preferably inserted through the axial face 34A of the end cap 34 and into the first and second fastener receiving channels 64 and 66, respectively, of the fixed structure 30 of the light bar 26.

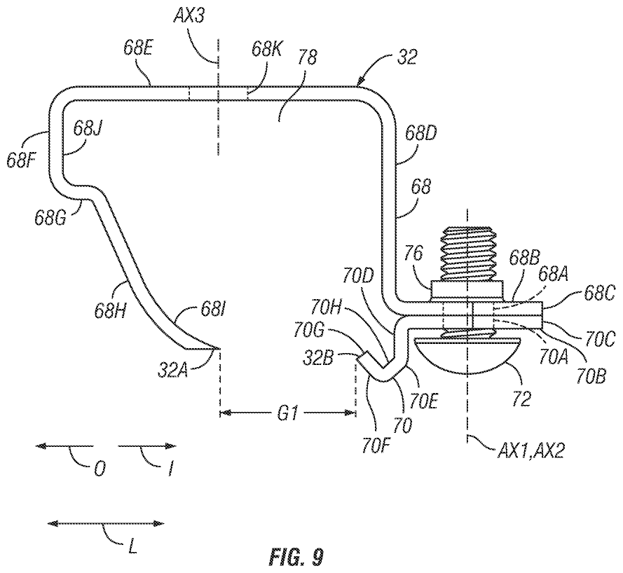

The bracket assembly 32 is configured to receive the fixed structure 30 of the light bar 26, as shown in FIGS. 6, 7 and 10. A gap G1, as shown in FIGS. 7 and 9, is defined between a first end 32A and a second end 32B of the bracket assembly 32 through which light 80 is configured to be emitted by the light source L1. The gap G1 between the first and second ends 32A and 32B of the bracket assembly 32 facilitates emitting light 80 from the light source L1. The gap G1 preferably extends substantially continuously in a longitudinal direction of the vehicle.

The bracket assembly 32 includes a first bracket member 68 and a second bracket member 70, as shown in FIGS. 7-9. The first bracket member 68 includes a first fastener opening 68A and the second bracket member 70 includes a second fastener opening 70A. The first and second fastener openings 68A and 70A are configured to receive a fastener 72 to secure the second bracket member 70 to the first bracket member 68. As shown in FIGS. 5-9, the bracket assembly 32 does not extend around an entirety of the outer surface of the fixed structure 30 of the light bar 26.

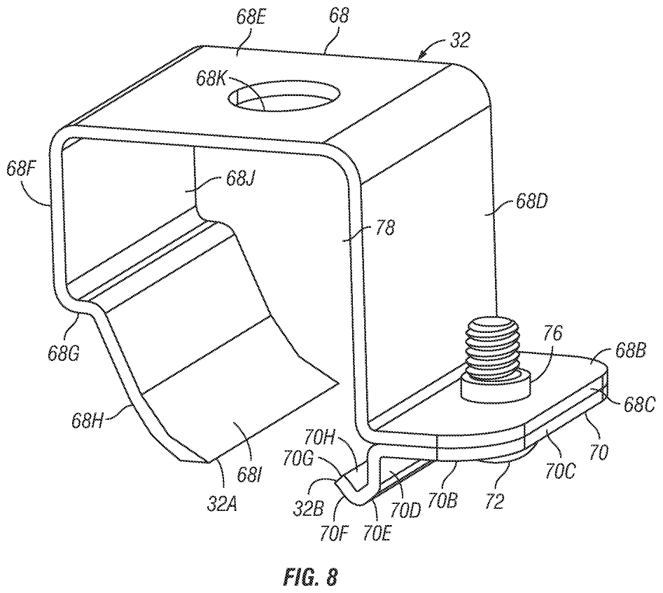

The first bracket member 68 includes a first flange 68B in which the first fastener opening 68A is disposed, as shown in FIGS. 8 and 9. The fastener opening 68A has a longitudinal axis AX1. An end surface 68C of the first flange 68B is an inboard-most end of the first bracket member 68. In other words, the end surface 68C is disposed furthest inboard in the inboard direction I of the vehicle.

A first leg 68D extends substantially perpendicularly from the first flange 68B, as shown in FIGS. 8 and 9. A second leg 68E extends substantially perpendicularly from an end of the first leg 68D. A third leg 68F extends substantially perpendicularly from the second leg 68E. A fourth leg 68G extends substantially perpendicularly from an end of the third leg 68F. A flexible member 68H extends downwardly from an end of the fourth leg 68G. The end of the flexible member 68H is the first end 32A of the bracket member 32. An inner surface 681 of the flexible member 68H is angled downwardly to facilitate emitting light from the light source L1 when the bracket assembly 32 is connected to the light bar 26. In other words, an inner surface 681 of the first end 32A of the bracket assembly 32 is angled downwardly and in the inboard direction I of the vehicle to substantially prevent unintended reflection of the light. The downward angle of the inner surface 681 allows an end 30C of the fixed structure 30 to be provided with a downward angle to facilitate emitting the light 80 from the first light source L1. Visibility of the light source from external of the vehicle is also substantially prevented.

The first bracket member 68 includes a first portion 68J configured to receive the first fastener receiving channel 64. The first portion 68J is defined by the second leg 68E, the third leg 68F and the fourth leg 68B, as shown in FIGS. 8 and 9. The second and third legs 68E and 68G are preferably substantially parallel. The third leg 68F is preferably substantially perpendicular to the second leg 68E and the fourth leg 68G. The first portion 68J defines a pocket configured to receive the first fastener receiving channel 64, as shown in FIG. 7.

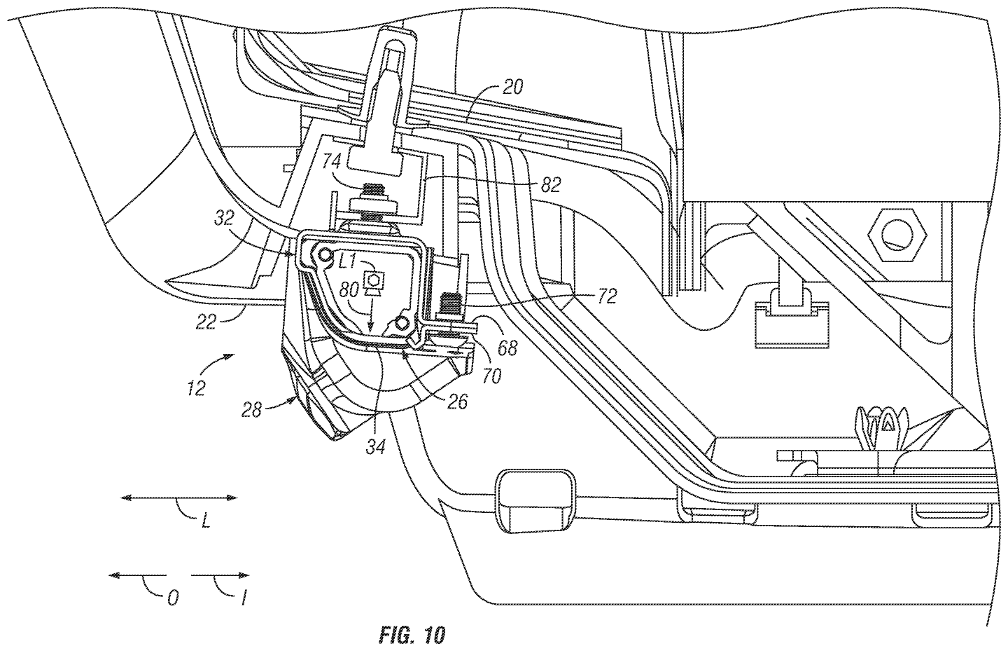

The first bracket member 68 includes a third fastener opening 68K configured to receive a fastener 74 to secure the bracket assembly 32 to the vehicle body structure 14 of the vehicle 10, as shown in FIGS. 7 and 10. The third fastener opening 68K is disposed in the second leg 68E of the first bracket member 68. The third fastener opening 68K is disposed in the vehicle outboard direction O with respect to the first fastener opening 68A in the first flange 68B of the first bracket member 68. The third fastener opening 68K has a third longitudinal axis AX3.

The first end 32A of the bracket assembly 32 is an outboard-most end of the first bracket member 68, as shown in FIGS. 7 and 9. The end surface 68C of the first flange 68B defines an inboard-most end of the first bracket member 68.

The second bracket member 70 includes a second flange 70B in which the second fastener opening 70A is disposed, as shown in FIGS. 8 and 9. The second fastener opening has a second longitudinal axis AX2. An end surface 70C of the second flange 70B is an inboard-most end of the second bracket member 70. In other words, the end surface 70C is disposed furthest inboard in the inboard direction I of the vehicle.

A first leg 70D extends substantially perpendicularly from an outboard end of the second flange 70B, as shown in FIGS. 8 and 9. A second leg 70E extends downwardly and in the outboard direction O from an end of the first leg 70D. A third leg 70F extends upwardly and in the outboard direction O from an end of the second leg 70E. The second and third legs 70E and 70F form a substantially V-shaped member. An end surface 70G of the third leg 70F is angled downwardly to facilitate emitting light 80 from the light source L1 when the bracket assembly 32 is connected to the light bar 26. In other words, an inner surface of the second end 32B of the bracket assembly 32 is angled downwardly and in an outboard direction O of the vehicle to substantially prevent unintended reflection of the light. The end surface 70G of the third leg 70F being angled downwardly allows the end 30D of the fixed structure 30 to be provided with a downward angle to facilitate emitting the light 80 through a gap G2 defined by the ends 30C and 30D of the fixed structure 30. Visibility of the light source from external of the vehicle is also substantially prevented.

The second bracket member 70 includes a second portion 70H configured to receive the second fastener receiving channel 66. The second portion 70H is defined by the first, second and third legs 70D, 70E and 70F of the second bracket member 70. The second portion 70H defines a pocket configured to receive the second fastener receiving channel 66, as shown in FIG. 7. The first portion 68J of the first bracket member 68 is disposed in the vehicle outboard direction O with respect to the second portion 70H of the second bracket member 70.

The second end 32B of the bracket assembly 32 is an outboard-most end of the second bracket member 70, as shown in FIGS. 7 and 9. The end surface 70C of the second flange 70B defines an inboard-most end of the second bracket member 70. As shown in FIGS. 8 and 9, the end face, or first face, 68C defined by an inboard-most end of the first bracket member 68 is substantially flush with the end surface, or second face, 70C defined by an inboard-most end of the second bracket member 68.

The gap G1 between the first and second ends 32A and 32B of the bracket assembly extends in a lateral direction L of the vehicle 10, as shown in FIG. 9. In other words, the gap G1 extends in a widthwise direction of the vehicle 10.

To assemble the light assembly 12, the fastener 74 is inserted through the third fastener opening 68K in the second leg 68E of the first bracket member 68. A nut 78 is disposed on the fastener 68 to prevent the fastener 74 from being separated from the first leg 68 of the bracket assembly 32.

The fixed structure 30 of the light bar 26 is then inserted into the cavity 78 defined by the first bracket member 68 of the bracket assembly 32. The flexible member 68H of the first bracket member 68 flexes in the outboard direction O, such that the fixed structure 30 of the light bar 26 can be rotated into the cavity 78 defined by the first bracket member 68. The first fastener receiving channel 64 and the strengthening portion 64A are received by the first portion 68J of the first bracket member 68. The first portion 68J preferably has a shape corresponding to a shape of the strengthening portion 66A.

The second bracket member 70 is then connected to the first bracket member 68 by aligning the first and second fastener openings 68A and 70A in the first and second flanges 68B and 70B of the first and second bracket members 68 and 70. The second portion 70H of the second bracket member 70 is engaged with the second fastener receiving channel 66 and the strengthening portion 66A of the fixed structure 30. The second portion 70H preferably has a shape corresponding to a shape of the strengthening portion 66A. A fastener 72 is inserted through the aligned first and second fastener openings 68A and 70A in the first and second flanges 68B and 70B of the first and second bracket members 68 and 70. A nut 76 is disposed on the fastener 72 to secure the first and second bracket members 68 and 70 together. The first and second longitudinal axes AX1 and AX2 are coincident, as shown in FIG. 9. The third longitudinal axis AX3 is substantially parallel to each of the first and second longitudinal axes AX1 and AX2. The process is repeated for each bracket assembly 32 connected to the light bar 26.

As shown in FIG. 10, a bracket 82 can be disposed between the vehicle body structure 14 and the bracket assembly 32 to secure the light bar 26 and the projector 28 of the light assembly 12 to the vehicle 10. Alternatively, the fastener 74 is connected to the rocker panel, or sill, 20 of the vehicle body structure 14 to secure the light bar 26 and the projector 28 of the light assembly 12 to the vehicle 10. The fastener 74 can be directly fastened to a component of the vehicle body structure 14, as shown in FIG. 7. As shown in FIGS. 1-3, three bracket assemblies 32 are used to secure the light assembly 12 to the vehicle body structure 14, although any suitable number of bracket assemblies 32 can be used. The bracket assembly 32 can be connected to the fixed structure 30 of the light bar 26 at a longitudinal location in which a light source L1 is disposed.

As shown in FIG. 7, a second gap G2 is defined between ends 30C and 30D of the fixed structure 30. The gap G2 extends in the longitudinal direction of the vehicle 10 preferably for an entirety of the length of the fixed structure 30. The gap G2 of the fixed structure 30 is smaller in the vehicle lateral direction L than the gap G1 between the ends 32A and 32B of the bracket assembly 32. The bracket assembly 32 secures the light assembly 12 to the vehicle, and substantially reduces interference with the light 80 emitted by the light source L1 of the light bar 26.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the light bar bracket assembly. Accordingly, these terms, as utilized to describe the present invention should be interpreted relative to a vehicle equipped with the light bar bracket assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A light bar bracket assembly for a vehicle comprising:
a light bar configured to receive a light source, the light bar having a first fastener receiving channel and a second fastener receiving channel configured to receive fasteners to secure the light bar to a projector; and
a bracket assembly configured to receive the light bar, a gap being defined by a first end and a second end of the bracket assembly through which light is configured to be emitted by the light source.

2. The light bar bracket assembly according to claim 1, wherein
the bracket assembly includes a first bracket member and a second bracket member, the first bracket member including a first fastener opening and the second bracket member including a second fastener opening, the first and second fastener openings being configured to receive a first fastener to secure the second bracket member to the first bracket member.

3. The light bar bracket assembly according to claim 2, wherein
the first bracket member includes a first portion configured to receive the first fastener receiving channel.

4. The light bar bracket assembly according to claim 3, wherein
the second bracket member includes a second portion configured to receive the second fastener receiving channel.

5. The light bar bracket assembly according to claim 2, wherein
the first bracket member includes a third fastener opening configured to receive a second fastener to secure the bracket assembly to a vehicle body structure of the vehicle.

6. The light bar bracket assembly according to claim 2, wherein
the first end of the bracket assembly is an outboard-most end of the first bracket member, an inner surface of the first end of the bracket assembly being angled downwardly and in an inboard direction of the vehicle.

7. The light bar bracket assembly according to claim 6, wherein
the second end of the bracket assembly is an outboard-most end of the second bracket member, an inner surface of the second end of the bracket assembly being angled downwardly and in an outboard direction of the vehicle.

8. The light bar bracket assembly according to claim 1, wherein
the gap between the first and second ends of the bracket assembly extends in a lateral direction of the vehicle.

9. The light bar bracket assembly according to claim 1, wherein
a first face defined by an inboard-most end of the first bracket member is substantially flush with a second face defined by an inboard-most end of the second bracket member.

10. The light bar bracket assembly according to claim 4, wherein
the first portion of the first bracket member is disposed in a vehicle outboard direction of the second portion of the second bracket member.

11. The light bar bracket assembly according to claim 5, wherein
first and second longitudinal axes of the first and second fastener openings are substantially parallel to a third longitudinal axis of the third fastener opening.

12. The light bar bracket assembly according to claim 1, wherein
the bracket assembly does not extend around an entirety of the outer surface of the light bar.

13. A vehicle light assembly comprising:
a vehicle body structure; and
a light assembly connected to the vehicle body structure, the light assembly including
a light bar including a first light source configured to emit light;
a projector connected to the light bar, the projector including a second light source configured to emit light; and
a bracket assembly connected to the light bar, a gap being defined by a first end and a second end of the bracket assembly through which the light is configured to be emitted by the first light source.

14. The vehicle light assembly according to claim 13, wherein
the bracket assembly includes a first bracket member and a second bracket member, the first bracket member including a first fastener opening and the second bracket member including a second fastener opening, the first and second fastener openings being configured to receive a first fastener to secure the second bracket member to the first bracket member.

15. The vehicle light assembly according to claim 14, wherein
the light bar includes a first fastener receiving channel and a second fastener receiving channel configured to receive second and third fasteners to secure the light bar to a projector;
the first bracket member includes a first portion configured to receive the first fastener receiving channel; and
the second bracket member includes a second portion configured to receive the second fastener receiving channel.

16. The vehicle light assembly according to claim 14, wherein
the first end of the bracket assembly is an outboard-most end of the first bracket member, an inner surface of the first end of the bracket assembly being angled downwardly and in an inboard direction of the vehicle.

17. The vehicle light assembly according to claim 16, wherein
the second end of the bracket assembly is an outboard-most end of the second bracket member, an inner surface of the second end of the bracket assembly being angled downwardly and in an outboard direction of the vehicle.

18. The vehicle light assembly according to claim 17, wherein
the gap between the first and second ends of the bracket assembly extends in a lateral direction of the vehicle.

19. The vehicle light assembly according to claim 15, wherein
the first portion of the first bracket member is disposed in a vehicle outboard direction of the second portion of the second bracket member.

20. The vehicle light assembly according to claim 13, wherein
the bracket assembly does not extend around an entirety of the outer surface of the light bar.
